(19) United States
(12) Patent Application Publication
(10) Pub. No.: US 2026/0237379 A1
(43) Pub. Date: Aug. 13, 2026

(54) SYSTEMS AND METHODS FOR USING NEURAL CODEC LANGUAGE MODEL FOR ZERO-SHOT TEXT-TO-SPEECH SYNTHESIS

(71) Applicant: Microsoft Technology Licensing, LLC, Redmond, WA (US)

(72) Inventors: Zhuo CHEN, Woodinville, WA (US); Yu WU, Beijing (CN); Long ZHOU, Beijing (CN); Shujie LIU, Beijing (CN); Yanqing LIU, Beijing (CN); Huaming WANG, Clyde Hill, WA (US); Jinyu LI, Bellevue, WA (US); Lei HE, Beijing (CN); Sheng ZHAO, Beijing (CN); Furu WEI, Beijing (CN); Chengyi WANG, Beijing (CN); Sanyuan CHEN, Beijing (CN); Ziqiang ZHANG, Beijing (CN)

(21) Appl. No.: 19/155,228

(22) PCT Filed: Mar. 2, 2023
(86) PCT No.: PCT/CN2023/079256

§ 371 Date: Aug. 8, 2025

(51) Int. Cl. G10L 13/047; G10L 15/00

(52) U.S. Cl. CPC G10L 13/047; G10L 15/005

(57) ABSTRACT

Systems and methods are provided for accessing a machine learning model configured as a zero-shot cross-lingual text-to-speech model which has been previously trained on a text-to-speech training dataset comprising different bilingual speech transcription pairs, obtaining a first text prompt in a first language, a second text prompt in a second language, a speech sample comprising audio data from an unseen target speaker, providing the first text prompt in the first language, the second text prompt in the second language, and the speech sample from the target speaker as inputs to the machine learning model, and finally, generating a personalized speech output based on the inputs and by at least converting the second text prompt in the second language using a synthesized voice of the target speaker based on the speech sample from the target speaker.

### BACKGROUND

Automatic speech recognition systems and other speech processing systems are used to process and decode audio data to detect speech utterances (e.g., words, phrases, and/or sentences). The processed audio data is then used in various downstream tasks such as search-based queries, speech-to-text transcription, language translation, etc. In contrast, text-to-speech (TTS) systems are used to detect text-based utterances and subsequently generate simulated spoken language utterances that correspond to the detected text-based utterances.

In most TTS systems, raw text is tokenized into words and/or phonetic units. Each word or phonetic unit is then associated with a particular phonetic transcription and prosodic unit, which forms a linguistic representation of the text. The phonetic transcription contains information about how to pronounce the phonetic unit, while the prosodic unit contains information about larger units of speech, including intonation, stress, rhythm, timbre, speaking rate, etc. Once the linguistic representation is generated, a synthesizer or vocoder is able to transform the linguistic representation into synthesized speech that is audible and recognizable to the human ear.

Typically, conventional TTS systems require large amounts of labeled training data, first for training the TTS system as a speaker-independent and/or multi-lingual TTS system. However, large amounts of labeled data are also required in particular for personalizing a TTS system for a new speaker and/or new language for which it had not been previously trained. In view of the foregoing, there is an ongoing need for improved systems and methods for building and using personalized TTS systems to generate personalized synthesized speech from text-based input.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems, methods, and devices for performing TTS processing and for generating and utilizing machine learning modules that are configured as zero-shot personalized for facilitating the generation of a personalized voice that will be used to generate synthesized speech from text-based input.

Some disclosed embodiments are directed toward systems and methods for generating cross-lingual personalized speech. For example, systems access a machine learning model configured as a zero-shot cross-lingual text-to-speech model which has been previously trained on a text-to-speech training dataset comprising a plurality of different bilingual speech transcription pairs. The systems also obtain a first text prompt in a first language, a second text prompt in a second language, and a speech sample comprising audio data from a target speaker, wherein the target speaker is an unseen target speaker such that no audio data from the target speaker was included in the text-to-speech training dataset. The systems then provide the first text prompt in the first language, the second text prompt in the second language, and the speech sample from the target speaker as inputs to the machine learning model and finally generate a personalized speech output based on the inputs and by at least converting the second text prompt in the second language using a synthesized voice of the target speaker based on the speech sample from the target speaker.

Some disclosed embodiments are also directed to generating modified personalized speech according to different attributes. For example, systems and methods are provided for accessing a machine learning model configured as a zero-shot cross-lingual text-to-speech model which has been previously trained on a text-to-speech training dataset. Systems also obtain a text prompt and a speech sample comprising audio data from a target speaker, wherein the target speaker is an unseen target speaker such that no audio data from the target speaker was included in the text-to-speech training dataset. Additionally, systems access an attribute ID configured to modify personalized speech output according to a particular attribute. Then, systems apply the text prompt, the speech sample, and the attribute ID to the machine learning model and generate personalized speech output based on the text prompt in a synthesized voice of the target speaker using the speech sample, the synthesized voice of the target speaker being modified according to the attribute ID.

Some disclosed embodiments are also directed toward systems and methods for accessing a machine learning model configured as a zero-shot cross-lingual speech-to-speech model which has been previously trained on a text-to-speech training dataset comprising a plurality of different bilingual speech transcription pairs. Systems obtain a speech sample comprising audio data from a target speaker, wherein the target speaker is an unseen target speaker such that no audio data from the target speaker was included in the text-to-speech training dataset. Next, systems generate a first transcription of the speech sample in a first language and a second transcription of the speech sample in a second language based on translating the first transcription of the speech sample into the second language. Systems then apply the first transcription of the speech sample, the second transcription of the speech sample, and the speech sample to the machine learning model and generate a personalized speech output based on the second transcription of the speech sample in the second language using a synthesized voice of the target speaker based on the speech sample from the target speaker.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments.

FIG. 2 illustrates an example diagram of a machine learning model, including inputs and outputs, configured to perform personalized text-to-speech generation.

FIG. 3 illustrates an example diagram of a machine learning model, including inputs and outputs, configured as an encoder-decoder network to generate and process acoustic tokens as part of personalized text-to-speech generation.

FIG. 4 illustrates an example diagram of a neural audio codec model.

FIG. 5 illustrates an example diagram of a machine learning model, including inputs and outputs, configured to perform cross-lingual personalized text-to-speech generation.

FIG. 6 illustrates an example diagram of a neural audio codec model used in generating cross-lingual personalized text-to-speech output.

FIG. 7 illustrates an example diagram of a neural audio codec language model which is applicable to zero-shot cross-lingual text-to-speech generation and zero-shot speech-to-speech generation.

FIG. 8 illustrates an example embodiment of a flow diagram having a plurality of acts associated with using a zero-shot personalized text-to-speech model to generate personalized text-to-speech output.

FIG. 9 illustrates an example embodiment of a flow diagram having a plurality of acts associated with using a zero-shot personalized text-to-model to generate modified personalized text-to-speech output.

FIG. 10 illustrates an example embodiment of a flow diagram having a plurality of acts associated with using a zero-shot personalized speech-to-speech model.

### DETAILED DESCRIPTION

Disclosed embodiments are directed towards improved systems, methods, and frameworks for facilitating the training and use of machine learning models to synthesize personalized speech and cross-lingual personalized speech for unseen target speakers.

Conventional TTS systems and methods utilize a cascaded TTS system that leverages an acoustic model, a vocoder, and Mel-spectrograms as the intermediate representations. While conventional TTS systems can synthesize speech from single or multiple speakers, it still requires high-quality clean data from the recording studio. Large-scale data crawled from the Internet cannot meet the requirement and leads to performance degradation of the TTS system. Because the amount of training data currently used is relatively small, current TTS systems still suffer from poor generalization. Additionally, speaker similarity and speech naturalness decline dramatically for unseen speakers in the zero-shot scenario. Current approaches to improve this try to leverage speaker adaptation and speaker encoding methods, which require additional training data, fine-tuning, complex pre-designed features, and/or heavy structure engineering. In contrast, instead of designing a complex and specific network for such problems, the present disclosure provides systems and methods which solve the problems discussed above by training a dual neural codec model with a large and diverse data training dataset comprising multi-speaker data.

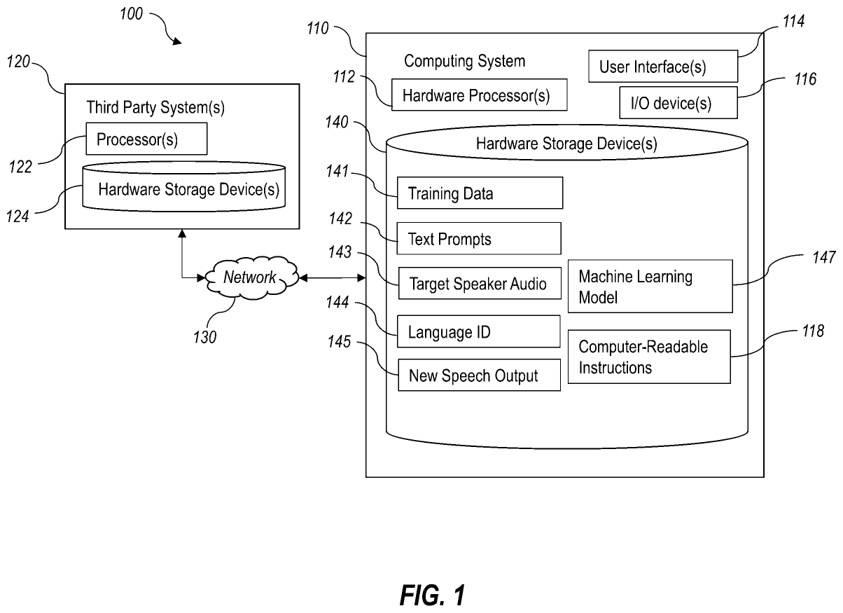

Attention will be first directed to FIG. 1, which illustrates the computing system 110 as part of a computing environment 100 that also includes remote system(s) 120 in communication (via a network 130) with the computing system 110. The computing system is in communication with remote system(s) 120 comprising one or more processor(s) 122, one or more of the computer-readable instructions 118, and one or more hardware storage device(s) 124. It is anticipated that, in some instances, the remote system(s) 120 further comprise databases housing data that could be used as training data, for example, text data not included in local storage. Additionally, or alternatively, the remote system(s) 120 include machine learning systems external to the computing system 110 and/or are software programs or applications.

The computing system 110, for example, includes one or more processor(s) (such as one or more hardware processor(s) 112) and a storage (i.e., hardware storage device(s) 140) storing computer-readable instructions 118 wherein one or more of the hardware storage device(s) 140 is able to house any number of data types and any number of computer-readable instructions 118 by which the computing system 110 is configured to implement one or more aspects of the disclosed embodiments when the computer-readable instructions 118 are executed by the one or more processor(s) 112. The computing system 110 is also shown including user interface(s) 114 and input/output (I/O) device(s) 116.

The computing system 110 is configured to generate, train, and use various machine learning models, including a zero-shot model 146 and cross-lingual model 147 (which is also a zero-shot model), which can generate personalized synthesized speech for a new target speaker. With regard to the use of the term “zero-shot”, as used in reference to the disclosed zero-shot models, it will be appreciated that the term generally means that the corresponding zero-shot model is capable of and configured to generate a personalized voice for a new target speaker in response to applying the zero-shot model to target reference speech (audio) from a new target speaker, and even though that model has not been previously applied to any target reference speech or audio associated with the new target speaker.

As shown in FIG. 1, hardware storage device(s) 140 is shown as a single storage unit. However, it will be appreciated that the hardware storage device(s) 140 is, a distributed storage that is distributed to several separate and sometimes remote system(s) 120. The computing system 110 can also comprise a distributed system with one or more of the components of computing system 110 being maintained/run by different discrete systems that are remote from each other and that each performs different tasks. In some instances, a plurality of distributed systems performs similar and/or shared tasks for implementing the disclosed functionality, such as in a distributed cloud environment.

The storage (e.g., hardware storage device(s) 140) includes computer-readable instructions 118 for instantiating or executing one or more of the models shown in computing system 110. The models are configured as machine learning models or machine learned models, such as deep learning models and/or algorithms and/or neural networks. In some instances, the one or more models are configured as engines or processing systems (e.g., computing systems integrated within computing system 110), wherein each engine comprises one or more processors (e.g., hardware processor(s) 112) and computer-readable instructions 118 corresponding to the computing system 110. In some configurations, a model is a set of numerical weights embedded in a data structure, and an engine is a separate piece of code that, when executed, is configured to load the model, and compute the output of the model in the context of the input audio.

The hardware storage device(s) 140 are configured to store and/or cache in a memory store the different data types including the training data 141, the text prompts 142, the acoustic prompts 143, attribute IDs 144, and synthesized speech 145, described herein.

### Training Data

Training data 141 is used to initially train the zero-shot model 146 and/or the cross-lingual model 147. For example, the zero-shot method described herein for speaker voice cloning beneficially utilizes a well-trained multi-speaker TTS source model. The machine learning model (e.g., model 100) is trained with a corpus (e.g., training data 141) consisting of thousands of hours of multi-speaker speech data. In some instances, the training data comprises approximately 60 k hours of speaker data. The corpus includes speaker data in a single language, or alternatively, speaker data in multiple languages. When the original audio data included in the corpus is audio-only, the system employs a speech recognition model to generate transcriptions for the speaker audio data.

Compared to previous TTS training datasets which require very clean audio data for training data, systems herein are able to utilize noisy speech data and even transcripts that include some errors because the disclosed embodiments provide for an approach that is robust to the noise and errors and is able to generalize accurately by leveraging the large dataset. Conventional systems are usually trained with dozens or hundreds of hours of speaker data, which is in contrast to the thousands of hours of training data which is utilized in disclosed embodiments. Because the disclosed embodiments are able to use neural codec language modeling, the systems and methods are able to perform in-context learning. Conventional systems are limited in this aspect.

### Text Prompts

The text prompts 142 comprise sequences of characters, symbols, and/or numbers extracted from a variety of sources. For example, the text prompts 142 comprises text message data, contents from emails, newspaper articles, webpages, books, mobile application pages, etc. In some instances, the characters of the text prompts 142 are recognized using optical text recognition of a physical or digital sample of text prompts 142. Additionally, or alternatively, the characters of the text prompts 142 are recognized by processing metadata of a digital sample of text prompts 142. Text prompts 142 are processed by the zero-shot model 146 in order to generate synthesized speech 145.

### Acoustic Prompts

Natural language audio is used for the new target speaker's speech samples (e.g., acoustic prompts 143). Natural language audio is extracted from previously recorded files such as video recordings having audio or audio-only recordings. Some examples of recordings include videos, podcasts, voicemails, voice memos, songs, etc. Natural language audio is also extracted from actively streaming content which is live continuous speech such as a news broadcast, phone call, virtual or in-person meeting, etc.

In some instances, a previously recorded audio file is streamed. Natural audio data comprises spoken language utterances without a corresponding clean speech reference signal. Natural audio data is recorded from a plurality of sources, including applications, meetings comprising one or more speakers, ambient environments including background noise and human speakers, etc. It should be appreciated that natural language audio comprises one or more spoken languages of the world's spoken languages. Thus, the zero-shot model 146 is trainable in different languages, where the source language of the training data 141 and the source language of the acoustic prompts 143 are the same.

### Attribute IDs

Attribute IDs 144 refer to the additional model parameter guide, which modifies, during inference or run-time, the personalized synthesized speech according to a particular attribute. For example, if the attribute ID is a language ID corresponding to a particular language, then the personalized synthesized speech is modified to include an accent associated with the corresponding language.

If the attribute ID is an emotion ID corresponding to a particular emotion, then the personalized synthesized speech is modified to convey the corresponding emotion, even if the emotion is different from the emotion associated with the target speaker's acoustic prompt. If the attribute ID is a speaking style ID corresponding to a particular speaking style, then the personalized synthesized speech is modified to be generated in the particular speaking style, even if the speaking style corresponding to the speaker style ID is different from the speaker style associated with the target speaker's acoustic prompt.

### Synthesized Speech

The synthesized speech 145 comprises synthesized audio data that has been generated by the zero-shot model 146 and/or the cross-lingual model 147. The synthesized speech 145 comprises speech utterances corresponding to words, phrases, and sentences recognized in the text prompts 142. The synthesized speech 145 uses a cloned voice of the target speaker based on the target speaker's acoustic prompt and a text prompt. The synthesized speech 145 speech utterances can be generated in different target speaker voices (i.e., cloned voices), different languages, different speaking styles, etc. The synthesized speech 145 speech utterances are characterized by the target speaker's speech features (e.g., acoustic features, linguistic features, and/or prosodic features). The synthesized speech 145 is beneficially generated to mimic natural language audio (e.g., the natural speaking voice of the target speaker).

By implementing the disclosed embodiments in this manner (e.g., by using a computing system such as computing system 110), many technical advantages over existing systems are realized, including the generation and utilization of a high-quality TTS system architecture, which is sometimes referred to herein as a zero-shot personalized text-to-speech model. The zero-shot model 146 and cross-lingual model 147 are capable of generating a personalized voice for a new target speaker without applying the model to new labeled training data associated with the new target speaker and without sacrificing the quality of the synthesized speech, as compared to conventional systems that do require additional training with new labeled training data.

Conventional zero-shot processing systems require additional training because they rely on techniques that utilize a speaker verification system to generate speaker embeddings that are fed into their Text-to-speech (TTS) systems without capturing the prosodic features of a target speaker, such as the fundamental frequency, energy, and duration of the target speaker, and even though the prosodic features play an important role in voice cloning.

By implementing the disclosed embodiments, TTS systems, such as computing system 110, are able to generate synthesized speech that is more natural and expressive, thereby increasing the synthesized speech's similarity to natural spoken language. Disclosed systems are able to synthesize a personalized voice (i.e., personal voice; cloned voice) for a target speaker using only a few audio clips without text transcripts from that speaker. After undergoing a training process, the TTS systems can clone specific characteristics of the target speaker which are incorporated into the personalized voice. The zero-shot methods disclosed herein enable cloning speaker voices by using only a few seconds of audio without corresponding text transcription from a new or unseen speaker as a reference. And, as described, the disclosed systems are able to quickly clone the target speaker's characteristics by the speaker information that is extracted from the few seconds of reference audio.

To clone an unseen voice, the systems only use the input of speaker information into the source model to directly synthesize speech for the new target speaker, without an additional training process. By using a zero-shot method for voice cloning, training computation costs are significantly reduced both in training time and because new sets of training data for the new target speaker do not need to be generated.

It will be appreciated that this is another benefit of the disclosed embodiments over conventional zero-shot TTS systems that focus on monolingual TTS scenarios, which means their synthesized speech is generated in the same language as the reference speech. Unlike these conventional systems, the disclosed embodiments beneficially provide a framework for cross-lingual TTS voice cloning, which means synthesized speech can be generated in languages that are different from those corresponding to the reference audio.

Furthermore, when looking at the experimental results of the zero-shot model 145, the disclosed embodiments significantly outperform conventional models in terms of speech naturalness and speaker similarity. For example, machine learning model 200 achieves a +0.12 comparative mean option score (CMOS) and a +0.93 similarity mean option score (SMOS) improvement over conventional TTS systems. It also achieves a +0.04 CMOS score against ground truth, showing the synthesized speech of unseen speakers is as natural as human recordings. Moreover, the qualitative analysis shows that the disclosed embodiments are able to synthesize diverse outputs with the same text and target speaker, which benefits pseudo-data creation for generating training data for speech recognition tasks. The speech output from machine learning model 200 also keeps the acoustic environment (e.g., reverberation, or other environmental feature) and emotion of the acoustic prompt.

The foregoing benefits are especially pronounced in real-time applications for voice cloning and synthesizing speech, as well as cross-lingual applications. Some examples of real-time applications include Skype Translator and other speech translators in IoT Devices.

### Personalized TTS Generation

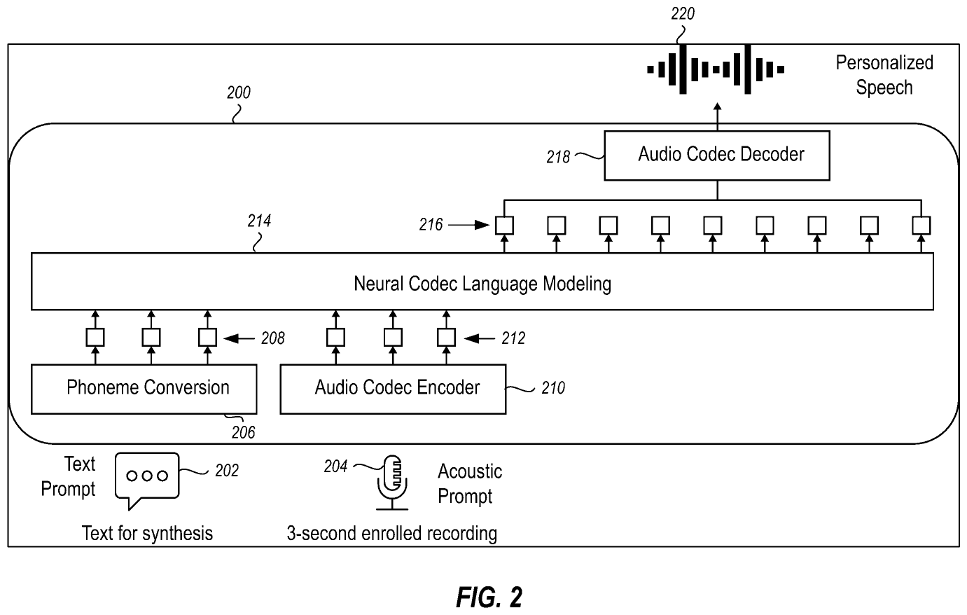

Attention will now be directed to FIG. 2, which illustrates an example diagram of a machine learning model (e.g., model 200), including inputs and outputs, configured to perform personalized text-to-speech generation. It should be appreciated that model 200 is representative of zero-shot model 146 of FIG. 1. As illustrated in FIG. 2, a text prompt 202 (e.g., from text prompts 142 of FIG. 1) and an acoustic prompt 204 (e.g., from acoustic prompts 143 of FIG. 1) are provided as inputs to model 200. The text prompt 202 is the text provided to the model for the synthesized speech.

The acoustic prompt 204, which is also referred to herein as the enrolled recording or target speaker sample speech, comprises a limited amount of audio data from the unseen target speaker. In some instances, the acoustic prompt 204 comprises a 3-second enrolled recording or a recording of another duration (e.g., 4 seconds, 5, seconds, 5-10 seconds, 10-15 seconds, but preferably less than 10 seconds). The acoustic prompt 204 can also be defined as audio data comprising a single spoken language utterance of a short duration (e.g., less than 10 seconds or even less than 5 seconds).

The text prompt 202 is converted (via phoneme conversion 206) to a phoneme sequence 208. The acoustic prompt 204 is converted to source acoustic tokens 212 using an audio codec encoder 210.

Based on the phoneme sequence 208 and source acoustic tokens 212, model 200 performs neural codec language modeling 214 and generates target acoustic tokens 216. The target acoustic tokens 216 are provided as input to the audio codec decoder 218, which converts the target acoustic tokens 216 to the personalized speech waveform 220. It should be appreciated that the audio codec encoder 210 and audio codec decoder 218 are part of the same audio codec model referenced herein.

As described above, conventional systems and methods for generating personalized speech include providing a phoneme input to a machine learning model, converting the phoneme input to a Mel-spectrogram, and then converting the Mel-spectrogram to a waveform. In contrast, the novel embodiments described herein convert a phoneme input (e.g., phoneme sequence 208) to a discrete code (e.g., target acoustic tokens 216) that can be processed to output the final waveform (e.g., personalized speech waveform 220) using a machine-learning model.

From the foregoing, and following, it will be appreciated that the disclosed embodiments provide technical improvements over conventional systems by being configured to train and use a neural codec language model for generating text-to-speech output as a conditional language model task, rather than a continual signal regression like conventional systems which use Mel-spectrogram intermediate outputs. This enables the system to use a broader range of initial training data and to require less training data for personalizing the TTS model.

For example, the machine learning model (e.g., model 200) described herein generates the discrete audio codec codes based on phoneme and acoustic prompts, corresponding to the target content and the speaker's voice. By configuring machine learning models like model 200 as illustrated in FIG. 2, systems and methods beneficially enable various speech synthesis applications, such as zero-shot TTS, speech editing, and content creation combined with other generative Al models (e.g., GPT-3). This allows for advanced prompting-based large-model techniques, like those used in GPTs) to be leveraged for the TTS tasks. The acoustic tokens also allow the system to generate diverse synthesized results in TTS by using different sampling strategies during inference and which enables a broader range of training data to be used.

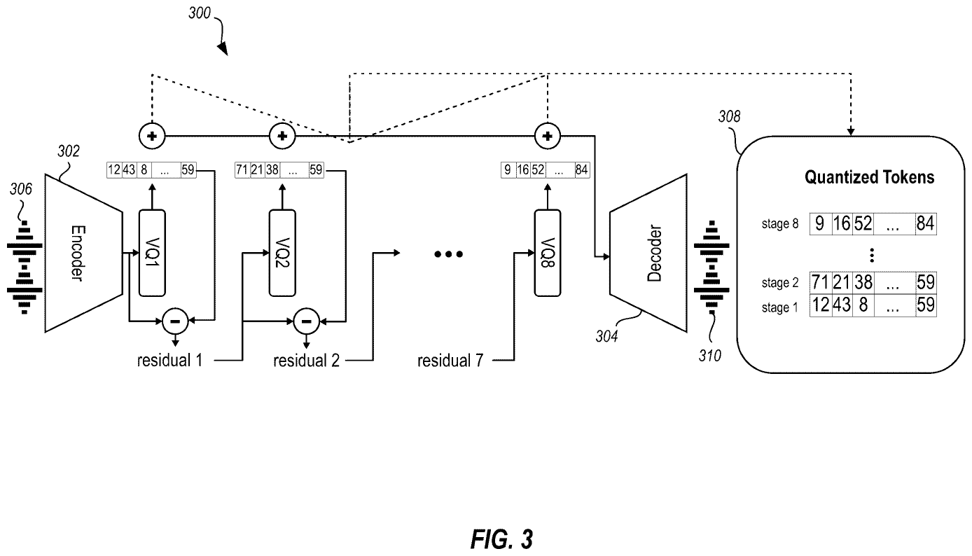

Attention will now be directed to FIG. 3, which illustrates an example diagram of a machine learning model, including inputs and outputs, configured as a neural audio codec model (e.g., model 300). As illustrated in FIG. 3, model 300 comprises an encoder 302 (representative of audio codec encoder 210 of FIG. 2), a plurality of vector quantizers (VQ) (e.g., VQ 1, VQ 2, ...., VQ 8), and a decoder 304 (representative of audio codec decoder of FIG. 2).

The acoustic prompt 306 (representative of acoustic prompt 202 of FIG. 2) from the target speaker is provided as input to the encoder 302. The first quantization layer (e.g., VQ 1) generates a first set of quantized acoustic tokens (tokens 12, 43, 8, ..., 59). This first set of quantized acoustic tokens corresponds to the codebook for stage 1 included in the Quantized Tokens 308. This token set is provided as input to the next quantization layer (e.g., VQ 2) as residual 1.

Based on the first set of quantized acoustic tokens as input, the second quantization layer generates a second set of quantized acoustic tokens (e.g., tokens 71, 21, 38, ...., 67) which corresponds to the codebook for stage 2 and is provided as input to a subsequent quantization layer (not shown) as residual 2. The acoustic tokens are processed through the rest of the quantizers until residual 7 is provided as input to the final quantization layer (e.g., VQ 8) which generates a final set of quantized acoustic tokens (e.g., tokens 9, 16, 52, .... 84). The final set corresponds to the codebook for stage 8. Each of the different sets of quantized acoustic tokens is added together and provided as inputs to the decoder 304. The decoder 304 then converts the concatenated set of acoustic tokens to the final waveform 310 (i.e., the synthesized speech).

Model 300 achieves many technical benefits over conventional systems. For example, since audio data is typically stored as a sequence of 16-bit integer values, a conventional generative model is configured to output 2\hat{ }16=65,536 probabilities per timestep to synthesize the raw audio. In addition, the audio sample rate exceeding ten thousand leads to an extraordinarily long sequence length, making it more intractable for raw audio synthesis. To this end, by implementing speech quantization like in model 300, and as included in disclosed embodiments herein, TTS systems are able to compress integer values and sequence length. For example, neural audio codec model 300 is able to represent speech in discrete tokens. To compress audio for network transmission, model 300 is able to encode waveform into discrete acoustic codes and reconstruct high-quality waveform even if the target speaker is unseen in the training data.

Compared to traditional audio codec approaches, the neural-based codec model (e.g. model 300) is significantly better at low bitrates. Additionally, the quantized tokens 308 contain sufficient information about the speaker and recording conditions to generate high-quality synthesized speech in the target speaker's voice. Compared to other quantization methods, neural audio codec model 300 achieves the following technical advantages: 1) It contains abundant speaker information and acoustic information, which helps to maintain speaker identity in reconstruction. 2) Disclosed systems and methods are able to utilize an off-the-shelf codec decoder to convert discrete tokens into a waver, without the additional efforts on vocoder training which has to process a continuous spectrum. 3) It also reduces the length of timesteps and sequence lengths to improve system/model efficiency.

As illustrated in FIG. 3, neural audio codec model 300 is a tokenizer and configured as an encoder-decoder model, such as a convolutional encoder-decoder model. The encoder 306 produces embeddings at a particular frequency (e.g., 75 Hz) for input waveforms at a different frequency (e.g., 24 kHz) which is a 320-fold reduction in the sampling rate. Each embedding is modeled by a residual vector quantization (RVQ), in which the system chooses a plurality of quantizers. In some instances, eight hierarchy quantizers are used with a plurality of entries (e.g., 1024 entries), as shown in FIG. 3. In some instances, neural audio codec model 300 is configured at 6 k bitrates for 24 kHz audio reconstruction. In such an example configuration, given a 10-second waveform, the discrete representation comprises a matrix with 750×8 entries, where 750=(24,000×10)/320 is the down sampled time step and 8 is the number of quantizers (e.g., VQ 1, VQ 2, ..., VQ 8).

It should be appreciated that while FIG. 3 illustrates 8 quantizers, neural audio codec model 300 can be configured according to different bitrate settings, resulting in different timesteps and different numbers of quantizers. For example, the larger the bitrate, the more quantizers and thus better the reconstruction quality. As another example, if the bitrate is set to 12 k, with 16 quantizers, the 10 second waveform would correspond to a matrix with 750×16 entries, thereby further improving the quality of the reconstructed audio.

In summary, with the discrete codes from all quantizers, the model 300 is able to generate real-valued embeddings and reconstruct an output waveform from the acoustic tokens at the desired frequency (e.g., 24 Hz).

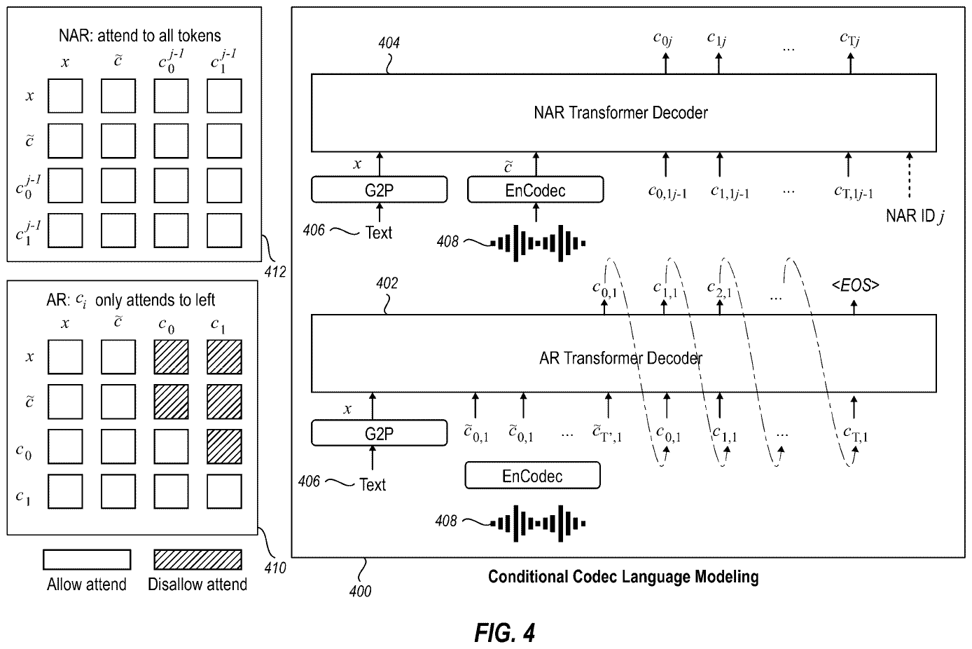

Attention will now be directed to FIG. 4, which illustrates an example diagram of a neural audio codec model (e.g., model 400) which is representative of model 300 of FIG. 3. Model 400 is shown having an autoregressive (AR) transformer decoder (e.g., AR model 402) and a non-autoregressive (NAR) transformer decoder (e.g., NAR model 404) which are configured to perform conditional codec language modeling.

In this example, text 406 is converted to a phoneme sequence “x” using the grapheme-to-phoneme (G2P) model (representative of phoneme conversion of FIG. 1). Acoustic prompt 408 is converted to source acoustic tokens (e.g., tokens c̆_{0,1}, c̆_{1,1}, ... c̆_{T,1}) using an audio codec encoder 410, which is representative of encoder 302.

As a note, given a dataset having an audio sample and its corresponding phoneme transcription, the above token notation is as follows: For example, “c” represents the two-dimensional acoustic code matrix, and T is the down sampled utterance length. The row vector of each acoustic code matrix (e.g., c_{t,:}) represents the codes (e.g., eight codes) for frame t and the column vector of each acoustic code matrix (e.g., c_{:j}) represents the code sequence from the j-th codebook, where j∈{1, ..., 8}. In this case, the set goes to 8 because the system is using 8 quantizers. However, as referenced before, the system can also use other numbers of quantizers for different bitrate settings.

Referring back to FIG. 4, the phoneme sequence and acoustic tokens are provided as input to the AR model 402. In the AR model 402, each source acoustic token attends only to the token to the left (i.e., the next subsequent token), see matrix 410. For example, token c_{0,1} attends to token c_{1,1}, token c_{1,1} attends to token c_{2,1}, token, and so on until the final token (e.g., c_{T,1}) is processed). In some instances, a special <EOS> token is appended to the source acoustic tokens.

The NAR model 404 also takes as input phoneme sequence “x” generated by the G2P model based on the text prompt 406. Similarly, the acoustic prompt 408 is converted to source acoustic token set c̆. All tokens in this set can attend to all other tokens in the set, see matrix 412. The output from the AR model 402, which is associated with the first quantization layer (e.g., VQ 1 of FIG. 3) is provided as input to the NAR model 404, which is associated with all subsequent quantization layers (e.g., VQ 2, ...., VQ 8 of FIG. 3).

Model 400 achieves many technical benefits over conventional systems and methods for quantization in TTS applications. For example, the neural audio codec model (also referred to as a neural speech codec model or model 400) allows the system to operate on discrete audio representations. Due to the residual quantization in the neural codec model, as described in FIG. 3, the tokens have a hierarchical structure. Notably, tokens from previous quantizers recover acoustic properties like speaker identity, while the consecutive quantizers learn fine acoustic details. Additionally, each quantizer is trained to model the residual from the previous quantizers.

To leverage data processing with such configurations, the disclosed embodiments utilize a neural audio codec model comprising multiple language models in the described hierarchal structures. For example, as illustrated in FIG. 4, the neural audio codec model comprises two conditional language models: an autoregressive (AR) decoder-only language model and a non-autoregressive (NAR) decoder-only language model.

For the discrete tokens from the first quantizer, the system trains the AR model, which is conditioned on the phoneme sequence and the acoustic prompt. For the discrete tokens from the second quantizer to the final quantizer, the system trains a NAR model.

Since the tokens do have access to each other in a NAR manner, to constrain the speaker identity, the acoustic prompt matrix is used as an acoustic prompt. Thus, the NAR model is conditioned on the phoneme sequence, the acoustic prompt, and the predicted acoustic tokens belonging to the previous codebooks (e.g., the set of tokens output from each quantization layer).

The combination of the AR model and the NAR model provides a good tradeoff between speech quality and inference speed. On the one hand, the rate of the generated speech should be consistent with the enrolled recording. It is, in some instances, difficult to train a length predictor for different speakers since each individual's speaking speed may differ substantially. In this case, the AR model compensates for this difficulty because of its flexibility in acoustic sequence length prediction. On the other hand, for consecutive stages, as the number of output slots follows the sequence length of the first stage, the NAR model beneficially reduces the time complexity of the token processing.

Many of the disclosed embodiments include the use of AR networks that are configured with AR-NAR architectures comprising specific quantities of quantization layers. It will be appreciated, however, that the disclosed functionality and benefits described herein can also be obtained by utilizing other types of AR networks that comprise the same or different number of quantization layers than those that are described. For example, in some alternative embodiments, a single AR network is provided and used to perform the disclosed text-to-speech synthesis, which is larger than and/or that may include more quantization layers than used by the disclosed dual AR-NAR architecture. Notably, regardless of the specific architecture used, the AR network is configured to process the input tokens and generate a final set of acoustic tokens which can then be reconstructed into the final waveform. Additional details regarding AR model configurations and functionality will now be provided.

### AR Model

The AR model generates tokens from the first quantizer. It comprises a phoneme embedding, an acoustic embedding, a transformer decoder, and a prediction layer. In order to generate speech with specific content, the system uses the phoneme sequence as the phoneme prompt of the language model. Thus, the model input is the concatenation of the phoneme sequence and the acoustic prompt.

In some instances, two special <EOS> tokens are appended after each of the aforementioned inputs. The system computes sinuous position embedding separately for prompt and input tokens. For the transformer model, each token can attend to tokens to the left, as illustrated by diagram 410. The model is optimized to maximize the probability of the next token in the first codebook. The system shares the parameters of the output projection layer with the parameters of the acoustic embedding.

In the AR model, the system does not explicitly extract an audio clip as the prompt during training. Instead, the training process is pure causal language model training. In this way, any prefix sequence is treated as a prompt for the latter part of the sequence. During inference, given an enrolled recording, the system will concatenate the phoneme sequence of the enrolled recording (i.e., the transcription of the acoustic prompt) and the phoneme sequence for synthesis (i.e., text prompt) together. Meanwhile, the acoustic token sequence of the enrolled recording is used as the prefix in AR decoding.

### NAR Model

When the system obtains the first quantizer codes by the AR model, the system then employs a NAR model to generate the codes of the subsequent quantizers. The NAR model has a similar architecture to the AR model, except that it contains a plurality of separate acoustic embedding layers. In some instances, the NAR model comprises 8 separate acoustic embedding layers. In each training step, the system randomly samples a training stage, wherein the model is trained to maximize the acoustic tokens from the quantizer codebook corresponding to the sampled training stage. The NAR model is trained to maximize the acoustic tokens from that corresponding quantizer codebook. The acoustic tokens from the first stage to the sampled stage are embedded and summed up as model input. The phoneme sequence is also regarded as the prompt of the language model. Additionally, to clone the unique voice of the given speaker, the system also uses the acoustic tokens from the enrolled speech as the acoustic prompt.

Specifically, the system first tokenizes the enrolled speech with the neural codec model. The embedded representations from all of the different codebooks are summed up as the acoustic prompt. To predict the acoustic tokens from the codebook corresponding to the sampled training stage, the transformer input is the concatenation of the inputs. The positional embeddings are also computed separately for prompts and the acoustic sequence. The current stage is injected into the network, for example with Adaptive Layer Normalization operator. Unlike AR, the NAR model allows each token to attend to all the input tokens in the self-attention layer, as illustrated in matrix 412. The system shares the parameters of the acoustic embedding layer and the output prediction layer, which means the weights of a particular prediction layer are the same as the prediction layer subsequent to that particular prediction layer.

Some technical benefits of the foregoing disclosed embodiments include the ability of the language model to predict labels for unseen inputs without additional parameter updates. In other words, the model can synthesize high-quality speech for unseen speakers without fine-tuning (i.e., perform in-context learning). This is an improvement over conventional systems and methods for personalized text-to-speech generation which require additional fine-tuning or experience dramatic quality degradation for unseen speakers.

For language models, prompting enables in-context learning in the zero-shot scenarios described herein. In summary, the system converts the text into a phoneme sequence and encodes the enrolled recording into an acoustic matrix. This forms the phoneme prompt and acoustic prompt, respectively. Both prompts are used in the AR and NAR models. For example, in the AR model, the system uses sampling-based decoding conditioned on the prompts. This is an improvement over beam search techniques which may lead the language model into an infinity loop, never to arrive at a prediction output. Furthermore, the sampling-based method significantly increases the diversity of the output. For the NAR model, the system uses greedy decoding to choose the token with the highest probability. Finally, the system uses a neural codec decoder to generate the waveform which is conditioned on the different code sequences. The acoustic prompt may or may not semantically relate to the speech being synthesized.

For example, in some embodiments where the acoustic prompt and the generated speech are not semantically related, the machine learning model is configured to generate content for unseen speakers. The model is given a text sentence, a segment of enrolled speech, and its corresponding transcription. The system prepends the transcription phoneme of the enrolled speech to the phoneme sequence of the given sentence as the phoneme prompt and uses the first layer acoustic token of the enrolled speech as an acoustic prefix. With the phoneme prompt and the acoustic prefix, the model generates the acoustic tokens for the given text, using the cloned voice of the speaker.

Additionally, or alternatively, in some embodiments where the acoustic prompt and generated speech are semantically related, the system uses a whole transcription and the first few seconds (e.g., 3 seconds) of the spoken utterance as the phoneme and acoustic prompts, respectively. The system then causes the model to generate continuations of speech for the rest of the transcription. The inference process is the same process as the previous embodiments, except that the enrolled speech and the generated speech are semantically continuous.

### Cross-Lingual Personalized Text-to-Speech Generation

End-to-end TTS synthesis has progressed over the years. However, conventional models cannot generate high-quality speech for cross-lingual applications. Conventional models suffer from the quality degradation because there is an inherent lack of data scarcity (the speaker typically only speaks the source language and therefore it is very difficult to get source-language pairs from the same speaker in the training data) and because of limited model capacity (e.g., the conventional TTS models are not powerful enough to transfer the speaker voice, speech background, and speaker emotion from the source language speech to the target language speech.

Conventional solutions to these problems include adding specific subnets of a speaker network for different speakers and an additional language network for language control. However, even with introducing multiple encoders for each language, these models still suffer loss in maintaining the speaker's identity, even when the model is explicitly trained using speech data from the target speaker. This degradation is further compounded during zero-shot scenarios. When such models attempt to synthesize target speech from an unseen source speaker, the models suffer from low speaker similarity and foreign language accent problems.

As an improvement over such models, disclosed embodiments are also directed to systems and methods for cross-lingual personalized speech synthesis, which transfers the speaker's voice from one language to another language. To facilitate an improvement in the aforementioned shortcomings of conventional TTS models, the following disclosed embodiments are directed to systems and methods for utilizing a cross-lingual neural codec language model, in which strong in-context learning capabilities provide a solution to achieve zero-shot cross-lingual speech synthesis. Because the cross-lingual neural codec language model is initially trained on thousands of hours of speech training data, the model is able to accurately transfer the speech characteristics (e.g., voice, prosody, emotion, speaking environment) of the target speaker to the synthesized cross-lingual speech, while also alleviating accent mismatch between the source language and the target language.

### Cross-Lingual TTS Model Training

For example, systems and methods are provided for training a cross-lingual neural codec language model. For example, the systems obtain multi-lingual transcription data by directly using ASR data or recognizing large unlabeled speech data to the pseudo transcripts with an offline ASR model. Then, the system converts the transcripts into phoneme sequences with a rule-based converter and the speech data to acoustic tokens using an offline neural codec encoder. With the multi-lingual acoustic tokens and phoneme sequences, the system trains the multi-lingual neural codec language model, which predicts the acoustic codec sequence of the target language speech from the target language text, with the source language speech as prompts. The predicted acoustic token sequence is then converted to the final speech in the target language by using an offline audio codec decoder.

The cross-lingual neural codec language model is trained with two large-scale datasets, containing thousands of hours (e.g., 70,000+hrs) of speech data in total. The first large-scale dataset comprises a data set of thousands of hours (e.g., 60,000+hrs) of unlabeled speech data, such as audiobook data, in a first language (e.g., English). The second large-scale dataset comprises thousands of hours (e.g., 10,000+hrs) of multi-domain multi-speaker speech data, such as ASR data, in a second language. In some instances, the second dataset comprises less speech data than the first dataset, for example, half the amount of speech data, a quarter of the speech data, an eighth of the speech data, or less). The combination of the two datasets makes a large multi-lingual multi-speaker multi-domain unclean speech data, which significantly improves the coverage of different speakers. Additionally, it enhances the cross-lingual neural codec language model's generalization capacity.

With regard to the foregoing, it will be appreciated that despite the specific examples of the large dataset sizes of training data described above, the referenced datasets can actually contain more training data than specified. In particular, any number of hours may be used to train the machine learning models, including but not limited to datasets having training data composed of over 70,000 hours, over 100,000 hours, or even over 200,000 hours. Training datasets of less than 70,000 hours can also be used. However, there is an inversely proportional relationship between the training dataset size needed to train the model and the runtime sample size that will be required to personalize the model. For instance, the larger the size of the training dataset that is used, the smaller the runtime sample will be required to personalize the model. During testing, it was found that a training data set of about 70,000 hours enabled a sample of about 3 seconds. If the training data set is larger than 70,000 hours, then the sample can sometimes be smaller than 3 seconds, while still obtaining desired results. If the training data set is smaller than 70,000, then it is preferable for the sample to be longer than 3 seconds.

Based on experimental results, the cross-lingual neural codec language model achieves a higher speaker similarity score than previous models for the unseen speaker. By training on a large scale (i.e., thousands of hours, instead of hundreds of hours like conventional TTS model training), the disclosed cross-lingual model significantly reduces the word error rate from 8.53 to 40.7 in the cross-lingual English TTS task, achieves the improvement gain of 3.17 BLEU scores as compared to baseline models in the S2S translation tasks, and achieves better speech naturalness. Furthermore, human evaluation also shows the disclosed cross-lingual model outperforms strong baseline models in terms of SMOS (4.00 vs. 2.88 in cross-lingual TTS, 4.12 vs. 3.06 in S2ST), and MOS (3.87 vs. 3.81 in S2ST).

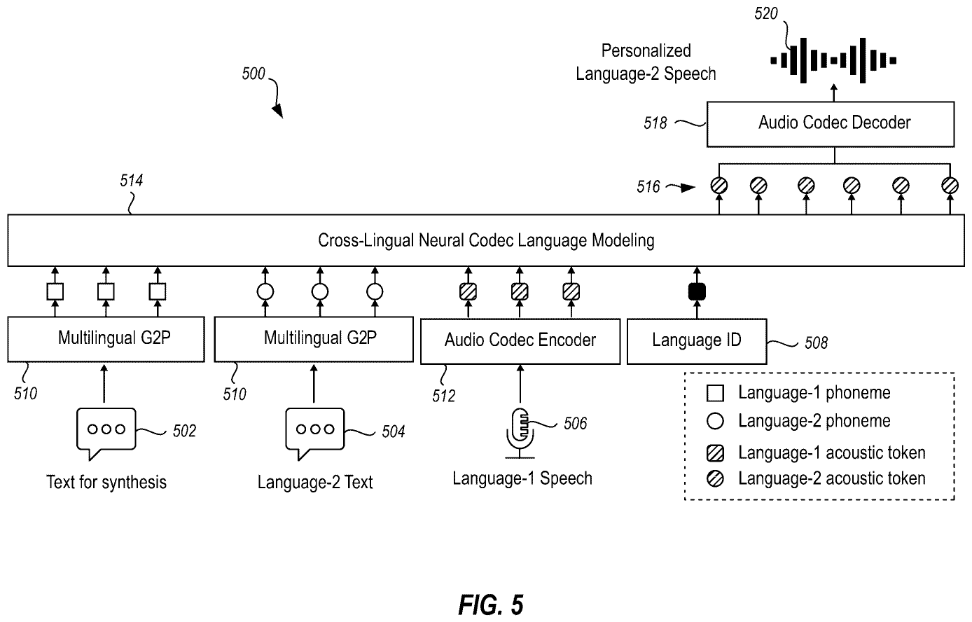

Attention will now be directed to FIG. 5, which illustrates an example diagram of a machine learning model (e.g., model 500), including inputs and outputs, configured to perform cross-lingual personalized text-to-speech generation. For example, in some instances model 200 is modified/extended to model 500, as illustrated in FIG. 5, which now includes a multi-lingual conditional codec language model to predict the acoustic codec sequence of the target language speech using an acoustic prompt comprising source language speech and text prompts comprising source language text and target language text. It should also be appreciated that model 500 is representative of the cross-lingual model 147 of FIG. 1.

As illustrated in FIG. 5, multiple text prompts (e.g., from text prompts 142 of FIG. 1), including: language-1 text (e.g., source text prompt 502) and language-2 text (e.g., target text prompt 504) and acoustic prompt 506 (e.g., language-1 speech) (e.g., from acoustic prompts 143 of FIG. 1) are provided as inputs to model 500, along with language ID 508.

The acoustic prompt 506 (e.g., language-1 speech) is also referred to as the enrolled recording, or target speaker sample speech, and comprises a limited amount of audio data from the unseen target speaker. In some instances, the acoustic prompt comprises a 3-second enrolled recording, or audio data comprising a single spoken language utterance.

The language ID is used to guide the speech generation for specific languages. Without language ID, the model may be confused when selecting suitable acoustic tokens for the specific language speech since it is trained with multi-lingual data, and the input text is converted to phonemes. Additionally, some languages have very different characteristics. For example, Chinese is a tone language while English is a non-tone language, which increases the task difficulty of speech synthesis.

By adding a language ID to the input of the cross-lingual neural codec model, the model is guided to generate speech in the right speaking characteristics and mitigate the foreign accent problem. In other words, for example, even though the acoustic prompt for the target speaker is in English and the generated target speech is in Chinese, the generated target speech will be characterized by both (i) the target speaker's voice based on the acoustic tokens derived from the target speaker's acoustic prompt and (ii) a Chinese accent guided by the language ID, even though the acoustic prompt had an English accent. It should be appreciated that the language ID of FIG. 5 can also be configured as an attribute ID, such as an emotion ID, or speaking style ID, or other attribute ID to modify the personalized speech, in either the monolingual or cross-lingual speech synthesis.

The text prompts are converted using a multilingual G2P model (e.g., multilingual G2P 510) to phoneme sequences. For example, language-1 text is converted to language-1 phoneme, and language-2 text is converted to language-2 phoneme. The acoustic prompt 506 is converted to source acoustic tokens (e.g., language-1 acoustic tokens) using an audio codec encoder 512, which is representative, in some instances, of the audio codec encoder of FIG. 4).

In some alternative embodiments, the systems are configured to utilize a text tokenizer instead of the phoneme tokenizer (e.g., G2P model) to convert the text prompts into word tokens. These word tokens, along with the source acoustic tokens, are provided as input to the subsequent machine learning model layers to generate the final target acoustic tokens. Other types of tokenizers configured to convert character or text strings into tokens may also be utilized in similar processes.

Referring back to FIG. 5, based on the phoneme sequences and source acoustic tokens, model 500 performs neural codec language modeling 514 and generates target acoustic tokens 516 (e.g., language-2 acoustic tokens). The target acoustic tokens 516 are provided as input to the audio codec decoder 518, which converts the target acoustic tokens 516 to the personalized speech waveform 520 (e.g., personalized language-2 speech). It should be appreciated that the audio codec encoder 512 and audio codec decoder 518 are part of the same audio codec model referenced herein.

Machine learning model 500 achieves many of the same technical benefits as machine learning model 200, including additional cross-lingual technical benefits. For example, model 500 inherits strong in-context learning capabilities and can be used for zero-shot cross-lingual TTS synthesis. It can even be used for zero-shot speech-to-speech (STS) translation tasks as well. Model 500 generates high-quality speech in the target language using limited speech (e.g., only one speech utterance) in the source language as a prompt while maintaining the unseen speaker's voice, emotion, and acoustic environment. Furthermore, machine learning model 500 alleviates the foreign accent problem that typically arises with cross-lingual speech generation. For example, in some instances, while the phonemes may be correctly generated for the new language in the voice of the speaker, the speaker's source language accent may also be used, instead of the correct target language accent. This problem is mitigated by using a language ID to control the speech synthesis.

Additionally, it should be noted, that disclosed embodiments for cross-lingual speech generation do not require cross-lingual speech data of the same speakers for model training, which significantly reduces the training data expense and training time when compared to conventional systems which need both target language acoustic prompts and source language acoustic prompts from the target speaker in order to generate the cross-lingual speech.

Using the phoneme sequences converted from the source text and target text, and using the acoustic tokens (that are generated from a neural audio codec encoder based on the acoustic prompt) as prompts, model 500 can generate the acoustic tokens in the target language, which will be converted to target speech with the corresponding audio codec decoder. The model 500 is applicable to various cross-lingual speech generation tasks, such as cross-lingual TTS generation and STS translation.

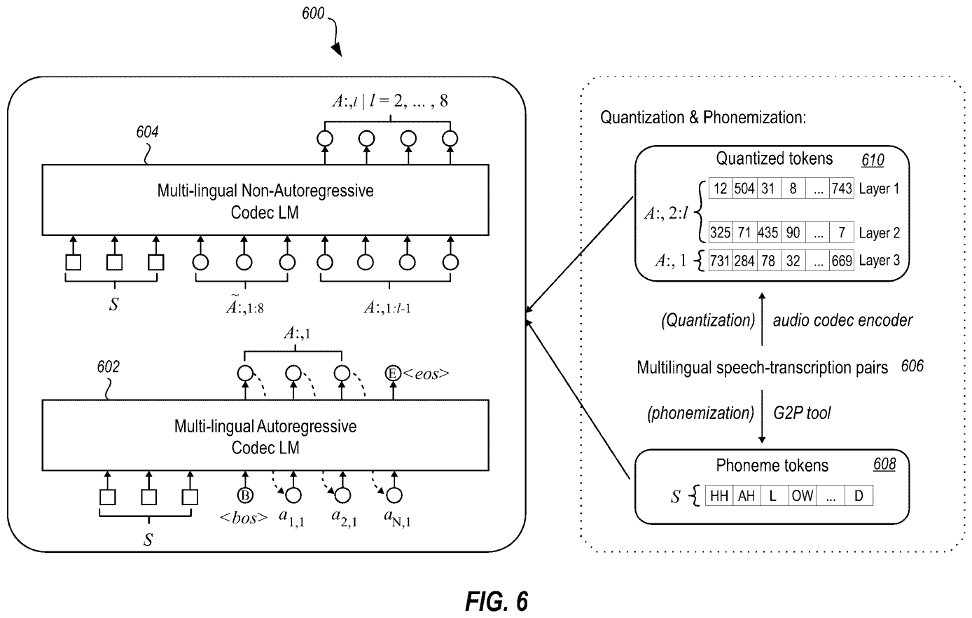

In contrast to conventional TTS models which regard TTS as a continuous regression task with Mel-spectrograms as intermediates, the present model regards TTS as a conditional language modeling task with audio codec codes as the intermediate representation. As described in further detail in FIG. 6, the cross-lingual neural codec language model employs a two-stage modeling method, in which the model first generates the acoustic tokens of the first layer from phoneme sequences using an AR language model, and then generates codec codes of the subsequent layers using a NAR transformer model. In order to learn cross-lingual acoustic conversion information for cross-lingual TTS and S2S translation tasks, the system utilizes a bilingual speech-transcription corpus to train the multilingual AR and NAR codec models. After training on the first large-scale speech-transcription dataset, the cross-lingual neural codec language model achieves strong in-context learning capabilities, generating personalized speech with limited speech fragments (e.g., 3-second enrolled recordings) as acoustic prompts.

### Cross-Lingual Neural Codec Language Sub-Models

Attention will now be directed to FIG. 6, which illustrates an example diagram of a cross-lingual neural codec language model (e.g., model 600) comprising a multi-lingual AR codec language model (multi-lingual AR model 602) and a multi-lingual NAR codec language model (multi-lingual NAR model 604) to generate acoustic tokens at different granularities. As illustrated in FIG. 6, the training data comprises multilingual speech-transcription pairs 606. On the one hand, the transcriptions undergo phonemization using a G2P model to generate a set of phoneme tokens 608 (e.g., S={HH, AH, L, OW, ..., D}. On the other hand, the speech data undergoes quantization using an audio codec encoder to generate a superset of quantized tokens (e.g., token set 610) comprising a set of quantized tokens for each quantization layer. For example, the token set for layer 1 is A_{:,1}={731, 284, 78, 32, ..., 669}. This token set is generated by the multi-lingual AR model 602. The token set for the subsequent layers comprises token set A_{:,2:1}. Layer 2 is associated with tokens {325, 71, 435, 90, ..., 7}, and layer l is associated with tokens {12, 504, 32, 8, ..., 743}. (Layer 3 through Layer l-1 are not shown). These token layer sets which are subsequent to Layer 1 are generated by multi-lingual NAR model 604.

As described above, an audio codec model is used as the acoustic tokenizer, which is an encoder-decoder model, in series with a plurality of quantization layers, as described in more detail in reference to FIG. 3. Each quantization layer produces quantized tokens comprising a plurality of entries at a particular frequency for input waveform. As illustrated in FIG. 6, the bitrate settings are configured such that 8 quantization layers (i.e., quantizers) are used, wherein the quantized tokens comprise 1024 entries at 75 Hz. However, it should be appreciated that the model can be configured according to different bitrate settings, which would result in different numbers of quantization layers.

### Multi-Lingual AR Model

The multi-lingual AR codec model is a unidirectional transformer decoder that autoregressively generates acoustic tokens based on the semantic tokens. In order to facilitate an improvement in the storage memory of the computing system, the multi-lingual AR codec model is used to predict the acoustic tokens of the first layer. This beneficially prevents the AR model from predicting acoustic tokens of multiple layers simultaneously, which would result in sequences that were too long to efficiently train and infer the model.

As illustrated in FIG. 6, S denotes the transcribed phoneme sequence and A denotes the first layer of acoustic tokens extracted from the corresponding speech X. As an autoregressive decoder, the model is trained to predict A for the first layer, token by tokens, conditioned on its prefix. It is optimized by maximizing the log-likelihood of the speech-transcription prompt data.

### Multi-Lingual NAR Model

Instead of using an autoregressive generation pattern, the multi-lingual NAR model is a non-autoregressive Transformer language model configured to iteratively generate rest acoustic tokens with the phoneme sequence (e.g., phoneme sequence “S”) and the acoustic tokens of the previous sentence (e.g., “Ã”) as prompts. Here, the previous sentence is expected to have the same characteristics of voice (speaker identity, speed, background, etc.) as the current sentence and is used to bring additional reference information for cloning the target voice. Like machine learning model 200, at each layer of the cross-lingual extension, the embeddings of quantization layers after the first quantization layer are summed up layer-wise as input.

### Cross-Lingual Inference

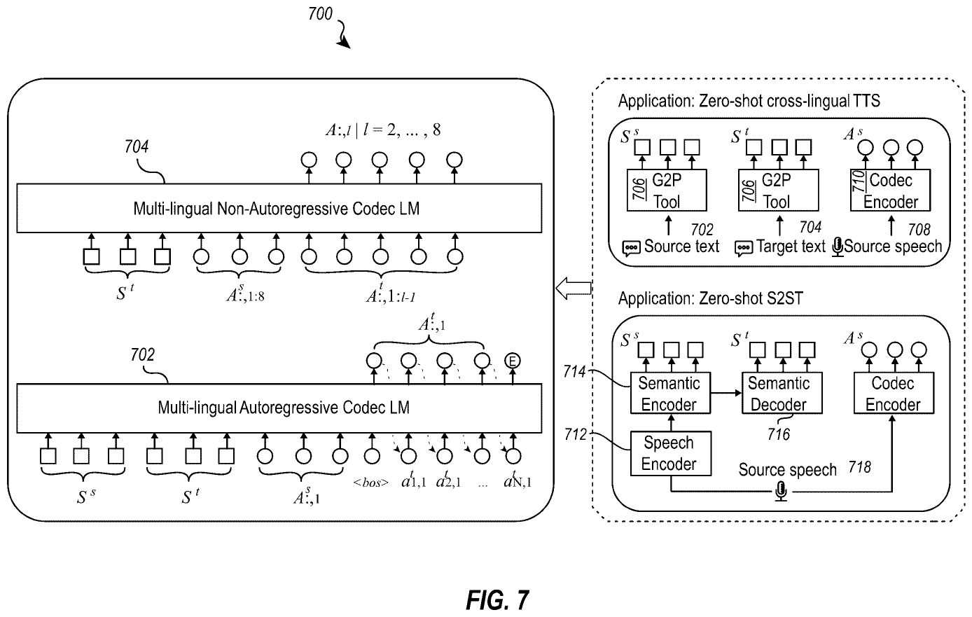

Attention will now be directed to FIG. 7, which illustrates an example diagram of a cross-lingual neural codec language model (e.g., model 600) which is applicable to Zero-shot cross-lingual TTS and Zero-shot S2ST. As described previously for zero-shot cross-lingual TTS, source text 702 and target text 704 are converted to phoneme sequences S^{s} and S^{t}, respectively, using a G2P tool 706 while the source speech (i.e., acoustic prompt 708) is converted to source acoustic tokens A^{s} using an audio codec encoder 710.

For example, after training, the cross-lingual neural codec language model is able to perform cross-lingual speech synthesis inference. The model first concatenates source phonemes S^{s} and target phonemes S^{s} as input, and takes first layer acoustic tokens A^{s:,1} as the decoding prefix for the multi-lingual AR model 602 to generate the first layer target acoustic tokens A^{t:,1}. As mentioned before, the model 600 adds the source language embedding and the target language embedding to each token embedding of S^{s} S^{t}, A^{s:,1} and A^{t>i,1} to control the tone of the final generated speech. After obtaining the first-layer target acoustic tokens from the multi-lingual AR model 602, the multi-lingual NAR model 604 is used to predict the rest of the layers of acoustic tokens (e.g., {A^{t:,l} |l=2, ... ,8} by greedy search (i.e., choosing the tokens with the maximum probabilities). Finally, an audio codec decoder is used to synthesize the target speech from the complete set of target acoustic tokens.

### Cross-Lingual Speech-to-Speech Translation

As illustrated in FIG. 7, the cross-lingual neural codec language model can be applied to both zero-shot cross-lingual TTS and zero-shot S2ST. Zero-shot S2ST is enabled by using an additional speech recognition and translation model, which is responsible for both recognizing and translating the source speech to the source and target phoneme sequences.

In some instances, the additional speech recognition and translation model is a unified modal speech-unit-text pre-training framework using hidden units at the modality bridge between speech and text. This supports various speech-to-text tasks, including both ASR and speech-to-text translation.

In some instances, the intermediate hidden units are replaced with phonemes, such that the additional speech recognition and translation model is able to predict both source and target phonemes simultaneously. Specifically, the additional model consists of a speech encoder 712, a semantic encoder 714, and a semantic decoder 716. All these components are pre-trained on an ASR corpus comprising source speech and source phonemes and a machine translation (MT) corpus comprises source phonemes and target phonemes, where the phoneme sequences are converted from the text.

After pre-training, the system uses triplet data-including source speech data, source phoneme data, and target phoneme data to fine-tune the components. The system performs multi-task learning with CTC loss on the semantic encoder for transcribing the source phonemes and the cross-entropy loss on the semantic decoder for translating the target phonemes.

FIG. 7 illustrates the inference process of speech-to-speech translation. For example, given a source speech sample (e.g., acoustic prompt 718), the speech recognition and translation model (ASR model) first generates the source phonemes Ss from the semantic encoder 714 and the target phonemes St from the semantic decoder 716. The system then uses the audio codec encoder 710 to compress the source speech into source acoustic tokens AS. Then, the system concatenates the source phonemes SS, the target phonemes St, and the source acoustic tokens AS, as the input of the model to generate the codec sequence for the target speech. The generated codec tokens are then converted to the final target speech with the decoder of the audio codec model.

### Example Methods

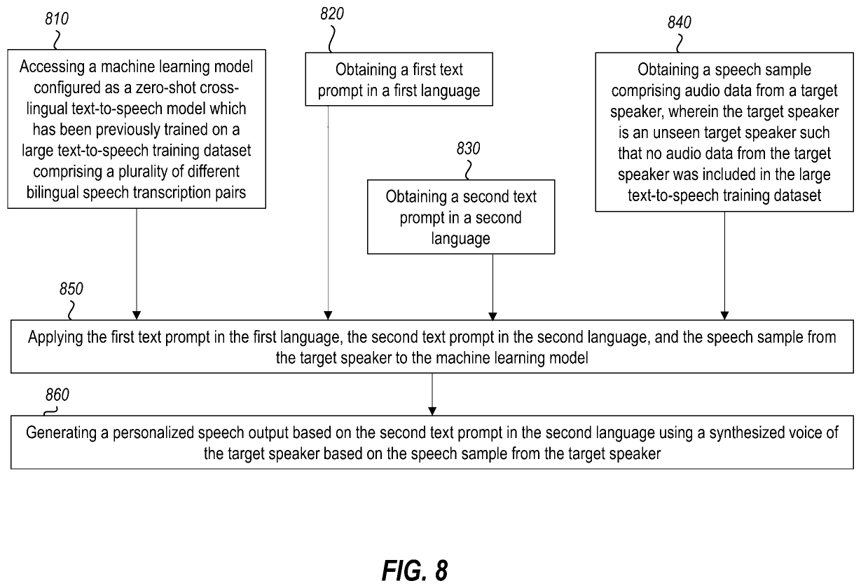

Attention will now be directed to FIG. 8, which illustrates an example embodiment of a flow diagram having a plurality of acts (e.g., act 810, act 820, act 830, act 840, act 850, and act 860) associated with a method implemented by a computing system (e.g., computing system 110) using a zero-shot personalized text-to-speech model (e.g., zero-shot model 146).

The first illustrated act includes an act of a system accessing a machine learning model (e.g., cross-lingua model 147) configured as a zero-shot cross-lingual text-to-speech model which has been previously trained on a text-to-speech training dataset (e.g., training data 141) comprising a plurality of different bilingual speech transcription pairs.

The system also obtains a first text prompt (e.g., text prompts 142) in a first language (act 820), a second text prompt (e.g., text prompts 142) in a second language (act 830), and a speech sample (e.g., acoustic prompts 143) comprising audio data from a target speaker, wherein the target speaker is an unseen target speaker such that no audio data from the target speaker was included in the text-to-speech training dataset (act 840).

The system provides or applies the first text prompt in the first language, the second text prompt in the second language, and the speech sample from the target speaker as inputs to the machine learning model (act 850) and utilizes the model to generate a personalized speech output (e.g., synthesized speech 145) based on the inputs by at least converting the second text prompt in the second language into a synthesized voice of the target speaker based on the speech sample from the target speaker (act 860).

In some embodiments, system also obtains a language ID (e.g., attribute IDs 144) associated with the second language that is configured to guide the generation of personalized speech output in the second language according to an accent or other speaking style/attribute associated with the second language.

It will be appreciated that the speech sample comprises audio data obtained from the target speaker comprising a single spoken language utterance, or alternatively a limited duration of enrolled recording from the target speaker (e.g., a 3 second, 4 second, 5 second snippet extracted from a single spoken language utterance). The duration of the sample may be predetermined based on known training qualities of the model.

As described in FIGS. 2-7, by providing the aforementioned inputs to the machine learning model, the systems are able to convert the text prompts into phoneme sequences and the speech sample into discrete acoustic tokens. For example, systems convert the first text prompt into a first phoneme sequence, the second text prompt into a second phoneme sequence, and the speech sample from the target speaker into a set of source acoustic tokens. By converting the speech sample, or acoustic prompt, into source tokens, the systems are able to leverage the in-context learning capabilities of the machine learning model and avoid processing the inputs using a continuous spectrum approach. The configuration and initial training can help reduce the amount of new sample data needed to personalize the model.

As described, the systems use the converted inputs to generate a set of acoustic tokens in the target language based on the first phoneme sequence, the second phoneme sequence, and the set of source acoustic tokens, such that the personalized speech output is generated based on the set of acoustic tokens in the target language. In such instances, the personalized speech output is generated by applying the set of acoustic tokens in the target language to an audio codec decoder. By implementing systems in this manner, the audio codec decoder is able to directly reconstruct the target acoustic tokens, while maintaining high speaker similarity, emotion, and acoustic environment of the speech sample.

As described in more detail above in reference to FIGS. 2-7 (in particular FIG. 3), the machine learning model is configured as a neural codec model that generates acoustic tokens at various quantization layers according to different granularities. For example, the machine learning model comprises a multi-lingual autoregressive codec language model that generates acoustic tokens at a first quantization layer and a multi-lingual non-autoregressive codec language model that generates acoustic tokens at a plurality of subsequent quantization layers based on the acoustic tokens generated at the first quantization layer. By utilizing both an AR model and an NAR model, the system achieves a beneficial balance between accuracy and time reduction for processing the different sets of tokens.

By configuring the AR model and the NAR model in a hierarchal fashion, tokens from previous quantization layers beneficially recover coarse acoustic properties, and subsequent quantization layers beneficially learn fine acoustic properties.

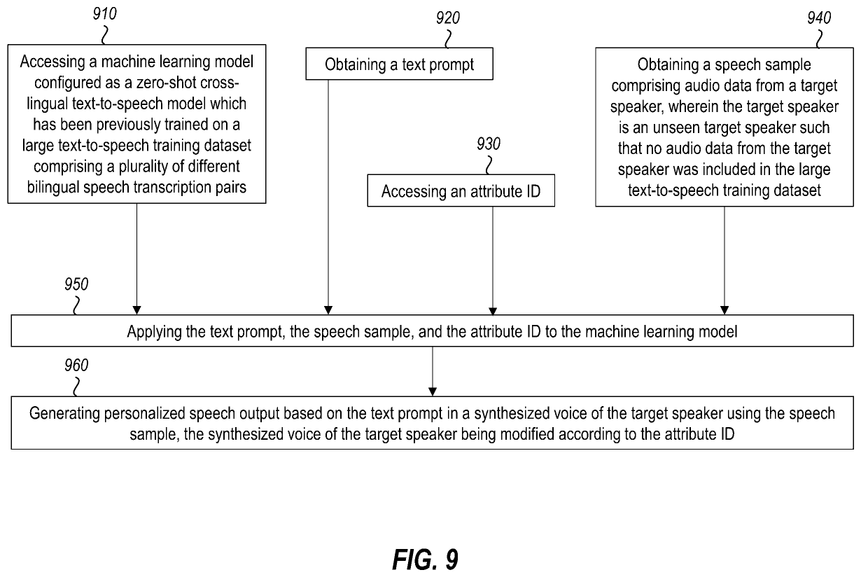

Attention will now be directed to FIG. 9 which illustrates a flow diagram 900 that includes various acts (act 910, act 920, act 930, act 940, act 950, and act 960) associated with exemplary methods that can be implemented by computing system 110 for generating modified personalized speech for a new target speaker using the zero-shot personalized text-to-speech models and configurations described above.

The first illustrated act includes an act of a system accessing a machine learning model (e.g., cross-lingual model 147) configured as a zero-shot cross-lingual text-to-speech model which has been previously trained on a text-to-speech training dataset (act 910).

The next act includes the system obtaining a text prompt (e.g., text prompts 142) (act 920) and a speech sample (e.g., acoustic prompts 143) comprising audio data from a target speaker, wherein the target speaker is an unseen target speaker such that no audio data from the target speaker was included in the text-to-speech training dataset (act 930).

The system also accesses an attribute ID (e.g., attribute ID) configured to modify personalized speech output according to a particular attribute (act 940). This attribute ID can be identified and accessed based on receiving a user input that designates a particular speaking accent, language and/or other speaking style to be used, for example, and which is mapped to the attribute ID and attribute ID features used by the model.

Subsequently, the system applies the text prompt, the speech sample, and the attribute ID to the machine learning model (act 950) and generate personalized speech output (e.g., synthesized speech 145) based on the text prompt in a synthesized voice of the target speaker using the speech sample, the synthesized voice of the target speaker being modified according to the attribute ID (act 960).

It will be appreciated that that attribute ID can be configured according to different attributes, such as different languages, different emotions, and/or different speaking styles. For example, in some instances, the attribute ID is a language ID corresponding to a particular language, such that the synthesized voice of the target speaker is modified to include an accent associated with the particular language. Additionally, or alternatively, in some instances, the attribute ID is an emotion ID corresponding to a particular emotion, such that the synthesized voice of the target speaker is modified to convey the particular emotion. Additionally, or alternatively, the attribute ID is a speaking style ID corresponding to a particular speaking style, such that the synthesized voice of the target speaker is modified according to the particular speaking style.

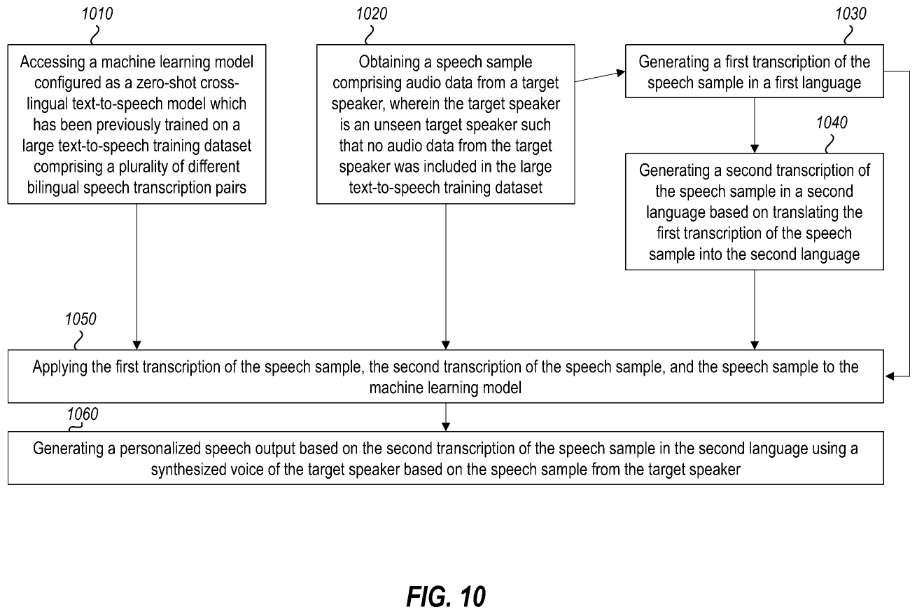

Attention will now be directed to FIG. 10, which illustrates a flow diagram 1000 that includes various acts (act 1010, act 1020, act 1030, act 1040, act 1050, and act 1060) associated with exemplary methods that can be implemented by computing system 110.

The first illustrated act includes an act of the system accessing a machine learning model (e.g., cross-lingual model 147) configured as a zero-shot cross-lingual text-to-speech model which has been previously trained on a text-to-speech training dataset (e.g., training data 141) comprising a plurality of different bilingual speech transcription pairs (act 1010).

The also obtains a speech sample (e.g., acoustic prompts 143) comprising audio data from a target speaker, wherein the target speaker is an unseen target speaker such that no audio data from the target speaker was included in the text-to-speech training dataset (act 1020).

Then, the system generates a first transcription of the speech sample in a first language (act 1030) and generate a second transcription of the speech sample in a second language based on translating the first transcription of the speech sample into the second language (act 1040).

Subsequently, the system applies the first transcription of the speech sample, the second transcription of the speech sample, and the speech sample to the machine learning model (act 1050) to, thereby, generate a personalized speech output (e.g., synthesized speech 145) based on the second transcription of the speech sample in the second language using a synthesized voice of the target speaker based on the speech sample from the target speaker (act 1060).

In some instances, systems also obtain a language ID (e.g., attribute IDs 144) associated with the second language, the language ID being configured to guide the generation of the personalized speech output in the second language according to an accent or other speaking associated with the second language. Such a language ID can be mapped to and based on user input that specifies a desired accent or other style to use for the second language.

In view of the foregoing, it will be appreciated that the disclosed embodiments provide many technical benefits over conventional systems and methods for generating a personalized voice for a new target speaker using a zero-shot personalized text-to-speech model. By implementing the disclosed embodiments in this manner, many technical advantages over existing systems are realized. For example, the disclosed embodiments provide a TTS framework with strong in-context learning capabilities by using language modeling with audio codec codes as an intermediate to replace the traditional Mel-spectrogram. The disclosed embodiments enable prompt-based approaches for zero-shot TTS, which does not require additional structure engineering, pre-designed acoustic features, or fine-tuning as in previous systems.

The disclosed embodiments provide a generalized TTS system in the speaker dimension by leveraging thousands of hours of semi-supervised data and is able to produce diverse outputs with the same input text while keeping the environment and speaker's emotion of the acoustic prompt. The synthesized speech is generated with high speaker similarity by prompting the zero-shot scenario. The disclosed embodiments are also directed to cross-lingual TTS and S2ST, which achieve the foregoing technical benefits, as well as cross-lingual specific technical benefits such as high-quality cross-lingual speech synthesis, by maintaining speaker similarity (in terms of identity, emotion, providing accurate translations, generating synthesized speech that sounds like natural speech.

### Example Computing Systems

Embodiments of the present disclosure may comprise or utilize a special purpose or general-purpose computer (e.g., computing system 110) including computer hardware and software. Embodiments within the scope of the present disclosure include, for example, physical storage media and other computer-readable media for carrying or storing computer-executable instructions and/or data structures. Such computer-readable media can be any available media that can be accessed by a general purpose or special purpose computer system.

Computer-readable media (e.g., hardware storage device(s) 140 of FIG. 1) that store computer-executable instructions (e.g., computer-readable instructions 118 of FIG. 1) are physical hardware storage media or devices that exclude transmission media. Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

Computer-readable media that carry computer-executable instructions or computer-readable instructions (e.g., computer-readable instructions 118) in one or more carrier waves or signals are transmission media. Transmission media can include a network and/or data links which can be used to carry, or desired program code means in the form of computer-executable instructions or data structures, and which can be accessed by a general purpose or special purpose computer.

Thus, by way of example, and not limitation, embodiments of the disclosure can comprise at least two distinctly different kinds of computer-readable media: physical computer-readable storage media/devices and transmission computer-readable media.

Combinations of the above are also included within the scope of computer-readable media, particularly when considering that computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions referenced herein are instructions and data which cause a general-purpose computer, special purpose computer, or special purpose processing device to perform a certain function or group of functions, such as the foregoing disclosed functoriality. The computer-executable instructions may be structured as binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present disclosure may be embodied in other specific forms without departing from its essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for generating cross-lingual personalized speech, the method comprising:
accessing a machine learning model configured as a zero-shot cross-lingual text-to-speech model which has been previously trained on a text-to-speech training dataset comprising a plurality of different bilingual speech transcription pairs;
obtaining a first text prompt in a first language;
obtaining a second text prompt in a second language;
obtaining a speech sample comprising audio data from a target speaker, wherein the target speaker is an unseen target speaker such that no audio data from the target speaker was included in the text-to-speech training dataset;
providing the first text prompt in the first language, the second text prompt in the second language, and the speech sample from the target speaker as inputs to the machine learning model; and
generating a personalized speech output based on the inputs and by at least converting the second text prompt in the second language using a synthesized voice of the target speaker based on the speech sample from the target speaker.

2. The method of claim 1, further comprising:
obtaining a language ID associated with the second language, the language ID being configured to guide the generation of the personalized speech output in the second language according to an accent associated with the second language.

3. The method of claim 1, wherein the speech sample comprises audio data obtained from the target speaker comprising approximately one spoken language utterance.

4. The method of claim 1, further comprising:
converting the first text prompt into a first phoneme sequence;
converting the second text prompt into a second phoneme sequence; and
converting the speech sample from the target speaker into a set of source acoustic tokens.

5. The method of claim 4, further comprising:
generating a set of acoustic tokens in the target language based on the first phoneme sequence, the second phoneme sequence, and the set of source acoustic tokens, such that the personalized speech output is generated based on the set of acoustic tokens in the target language.

6. The method of claim 5, wherein the personalized speech output is generated by applying the set of acoustic tokens in the target language to an audio codec decoder.

7. The method of claim 1, wherein the machine learning model is configured as a neural codec model that generates acoustic tokens at various quantization layers according to different granularities.

8. The method of claim 7, wherein the machine learning model comprises a multi-lingual autoregressive codec language model that generates acoustic tokens at a first quantization layer and a multi-lingual non-autoregressive codec language model that generates acoustic tokens at a plurality of subsequent quantization layers based on the acoustic tokens generated at the first quantization layer.

9. The method of claim 7, wherein tokens from previous quantization layers recover coarse acoustic properties and subsequent quantization layers learn fine acoustic properties.

10. A method for generating modified personalized speech, the method comprising:
accessing a machine learning model configured as a zero-shot cross-lingual text-to-speech model which has been previously trained on a text-to-speech training dataset;
obtaining a text prompt;
obtaining a speech sample comprising audio data from a target speaker, wherein the target speaker is an unseen target speaker such that no audio data from the target speaker was included in the text-to-speech training dataset;
accessing an attribute ID configured to modify personalized speech output according to a particular attribute;
applying the text prompt, the speech sample, and the attribute ID to the machine learning model; and
generating personalized speech output based on the text prompt in a synthesized voice of the target speaker using the speech sample, the synthesized voice of the target speaker being modified according to the attribute ID.

11. The method of claim 10, wherein the attribute ID is a language ID corresponding to a particular language, such that the synthesized voice of the target speaker is modified to include an accent associated with the particular language.

12. The method of claim 10, wherein the attribute ID is an emotion ID corresponding to a particular emotion, such that the synthesized voice of the target speaker is modified to convey the particular emotion.

13. The method of claim 10, wherein the attribute ID is a speaking style ID corresponding to a particular speaking style, such that the synthesized voice of the target speaker is modified according to the particular speaking style.

14. A method for generating personalized speech output, the method comprising:
accessing a machine learning model configured as a zero-shot cross-lingual text-to-speech model which has been previously trained on a speech-to-speech training dataset comprising a plurality of different bilingual speech transcription pairs;
obtaining a speech sample comprising audio data from a target speaker, wherein the target speaker is an unseen target speaker such that no audio data from the target speaker was included in the text-to-speech training dataset;
generating a first transcription of the speech sample in a first language;
generating a second transcription of the speech sample in a second language based on translating the first transcription of the speech sample into the second language;
applying the first transcription of the speech sample, the second transcription of the speech sample, and the speech sample to the machine learning model; and
generating a personalized speech output based on the second transcription of the speech sample in the second language using a synthesized voice of the target speaker based on the speech sample from the target speaker.

15. The method of claim 1, further comprising:
obtaining a language ID associated with the second language, the language ID being configured to guide the generation of the personalized speech output in the second language according to an accent associated with the second language.
